(19) United States
(12) Patent Application Publication
(10) Pub. No.: US 2026/0062064 A1
(43) Pub. Date: Mar. 5, 2026

(54) VEHICLE BODY REAR STRUCTURE

(71) Applicant: HONDA MOTOR CO., LTD., Tokyo (JP)

(72) Inventor: Naoki TANI, Tokyo (JP)

(21) Appl. No.: 19/302,490

(22) Filed: Aug. 18, 2025

(30) Foreign Application Priority Data
Aug. 28, 2024 (JP) 2024-146954

(51) Int. Cl. B62D 25/20

(52) U.S. Cl. CPC B62D 25/2027

(57) ABSTRACT

A vehicle body rear structure includes rear wheel housing parts and a rear floor panel part having rear frame coupling parts to be coupled with rear frames, which are integrally provided by die-cast molding. The rear wheel housing parts include bulged parts which are bulged inward in a vehicle width direction to cover rear wheels, and at least a part of the rear frame coupling parts is arranged in front of rear ends of the bulged parts.

### CROSS-REFERENCE TO RELATED APPLICATION

The present application claims the benefit of priority to Japanese Patent Application No. 2024-146954 filed on Aug. 28, 2024, the disclosures of all of which are hereby incorporated by reference in their entireties.

### TECHNICAL FIELD

The present invention relates to a vehicle body rear structure.

### BACKGROUND

In recent years, research and development has been conducted on lightweighting to contribute to energy efficiency, with the aim of enabling more people to easily access affordable, reliable, sustainable, and advanced energy. Referring to Chinese Patent Application Publication No. 117360634, there is disclosed a die-cast rear floor body structure in which a pair of right-left rear wheel coverings, a pair of right-left longitudinal beams provided along a lower end of the rear wheel coverings, a coupling beam to couple the pair of right-left longitudinal beams, and a pair of front-rear transverse beams, are integrated with each other.

### SUMMARY

In the structure above, rear frames are coupled to the die-cast rear floor body structure at a rear of the rear wheel covers (rear wheel housing). As a result, there arises a problem in that an entire length of a vehicle body (rear overhang) becomes longer, which increases weight and reduces design flexibility of the vehicle body.

The present invention has been made in view of the problem described above and provides a vehicle frame structure to achieve weight reduction and freedom improvement in vehicle body design, thereby contributing to improved energy efficiency.

To solve the problem described above, a vehicle body rear structure includes rear wheel housing parts and a rear floor panel part having rear frame coupling parts to be coupled with rear frames, which are integrally provided by die-cast molding. The rear wheel housing parts include bulged parts which are bulged inward in a vehicle width direction to cover rear wheels, and at least a part of the rear frame coupling parts is arranged in front of rear ends of the bulged parts.

According to the present invention, weight reduction of a vehicle body rear structure and freedom improvement in vehicle body design can be achieved, thereby contributing to improved energy efficiency.

### BRIEF DESCRIPTION OF THE DRAWINGS

FIG. 1 is a perspective view, seen from a diagonal upper front side, schematically showing a vehicle body rear structure according to an embodiment of the present invention;

FIG. 2 is a perspective view, seen from the diagonal upper rear side, schematically showing the vehicle body rear structure according to the embodiment of the present invention;

FIG. 3 is a side view schematically showing the vehicle body rear structure according to the embodiment of the present invention;

FIG. 4 is a plan view schematically showing the vehicle body rear structure according to the embodiment of the present invention;

FIG. 5 is a bottom view schematically showing the vehicle body rear structure according to the embodiment of the present invention;

FIG. 6 is a perspective view schematically showing a rear frame coupling part and a facing rib;

FIG. 7 is an enlarged view surrounded by a VII line in FIG. 5;

FIG. 8 is a cross-sectional view taken along a VIII-VIII line in FIG. 4;

FIG. 9 is a cross-sectional view taken along a IX-IX line in FIG. 4; and

FIG. 10 is a bottom view, showing a state with a drive unit attached, schematically showing the vehicle body rear structure according to the embodiment of the present invention.

### DETAILED DESCRIPTION

Next, a description is given of an embodiment of the present invention in detail with reference to accompanying drawings as appropriate. In the drawings, “front-rear” indicates a front-rear direction (vehicle body front-rear direction) of a vehicle travel direction, and “right-left” indicates right-left direction (vehicle width directions) as viewed from a driver's seat.

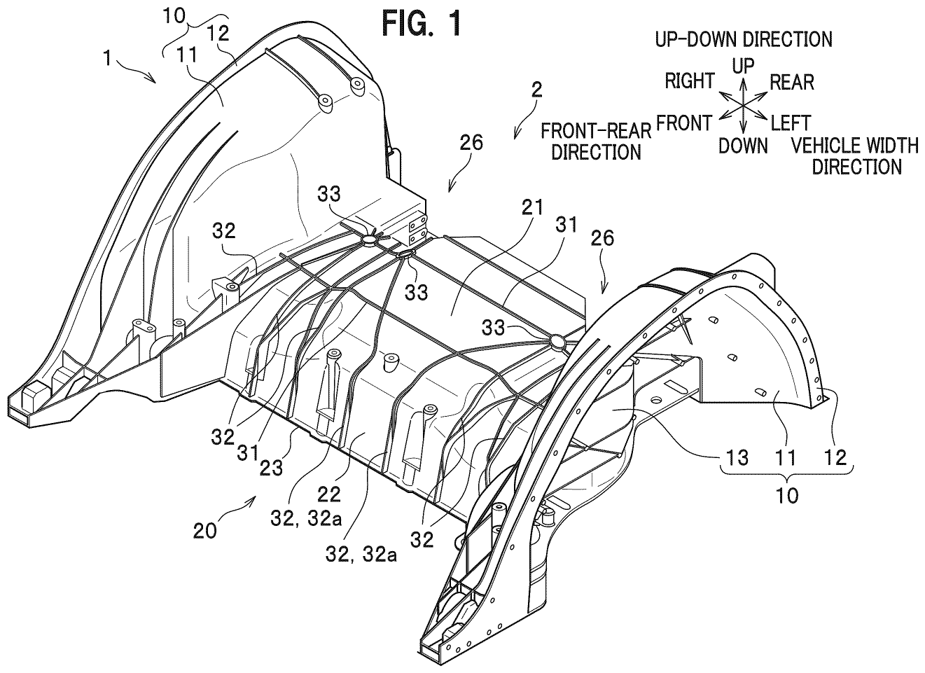

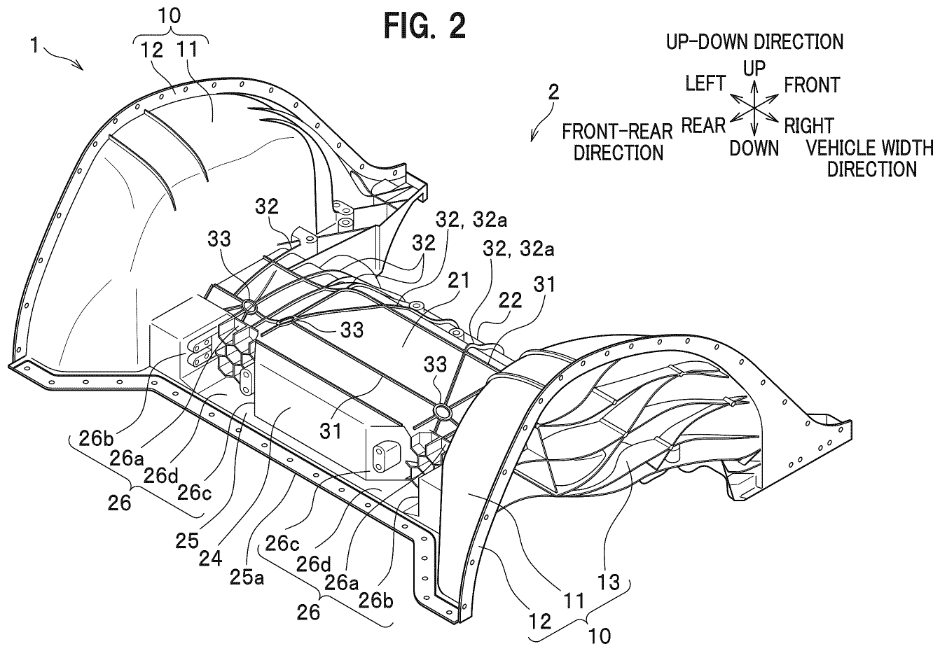

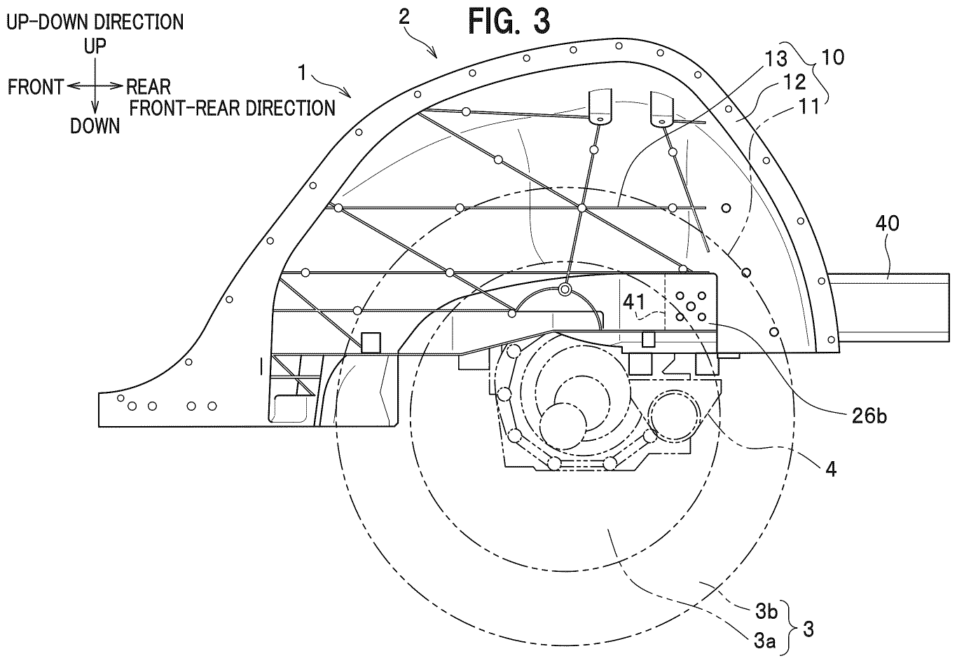

As shown in FIGS. 1 and 2, a vehicle body rear structure 1 according to the embodiment of the present invention is formed from a die-cast casting by a die-cast method (aluminum die-cast method) using aluminum as at least a part of a material. The vehicle body rear structure 1 has a die-cast part 2 as a die-cast casting, which includes a pair of right-left rear wheel housing parts 10 and a rear floor panel part 20 which couples the pair of right-left rear wheel housing parts 10, all of which being integrated as a single unit. Further, the vehicle body rear structure 1 includes a pair of right-left rear frames 40 (see FIG. 3) as separate parts from the die-cast part 2.

### <Rear Wheel Housing Part>

The rear wheel housing part 10 integrally includes a bulged part 11, a flange 12, and a plurality of ribs 13.

The bulged part 11 is a rear wheel housing main part which has a shape bulged inward in the vehicle width direction. An upper portion of a rear wheel 3 (see FIG. 3) is accommodated in the bulged part 11 on an outer side in the vehicle width direction.

The flange 12 extends outward of the bulged part 11 from an outer end in the vehicle width direction of the bulged part 11.

The rib 13 extends outward in the vehicle width direction from the bulged part 11.

### <Rear Floor Panel Part>

The rear floor panel part 20 is a plate-like part provided to couple the bulged parts 11 of the right-left rear wheel housing parts 10 with each other. The rear floor panel part 20, as a rear floor panel main body, includes an upper wall part 21, a front wall part 22, a first lower wall part 23, a rear wall part 24, and a second lower wall part 25.

### <<Upper Wall Part>>

The upper wall part 21 extends in the front-rear direction and in the vehicle width direction.

### <<Front Wall Part>>

The front wall part 22 extends downward from a front end of the upper wall part 21.

### <<First Lower Wall Part>>

The first lower wall part 23 extends forward from a lower end of the front wall part 22. A middle part in the vehicle width direction of the first lower wall part 23 forms a flange of the front wall part 22. Ends in the vehicle width direction of the first lower wall part 23 extend in front of the rear wheel housing parts 10.

### <<Rear Wall Part>>

The rear wall part 24 extends downward from a rear end of the upper wall part 21.

### <<Second Lower Wall Part>>

The second lower wall part 25 extends rearward from a lower end of the rear wall part 24. Ends in the vehicle width direction of the second lower wall part 25 extends toward rear sides of the rear wheel housing parts 10. A rear end of a middle part in the vehicle width direction of the second lower wall part 25 is positioned in front of a rear end of the rear wheel housing parts 10 (bulged parts 11) to form a notch 25a. The notch 25a is used to ensure component mounting space. Further, surface accuracy of the second lower wall part 25 is improved through machining after casting.

### <Rear Frame Coupling Part>

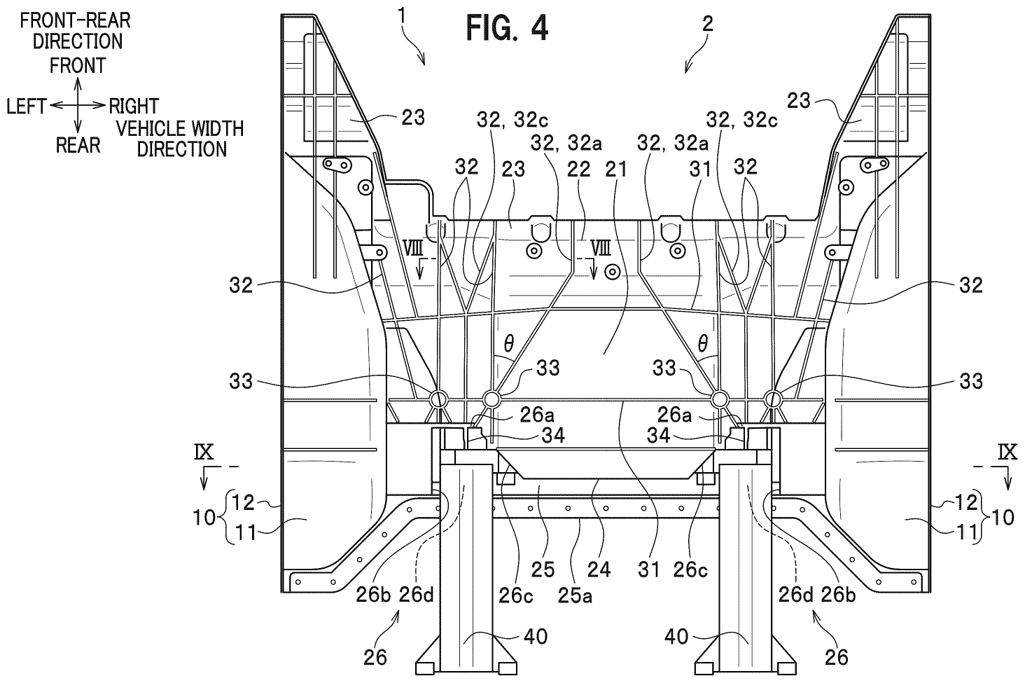

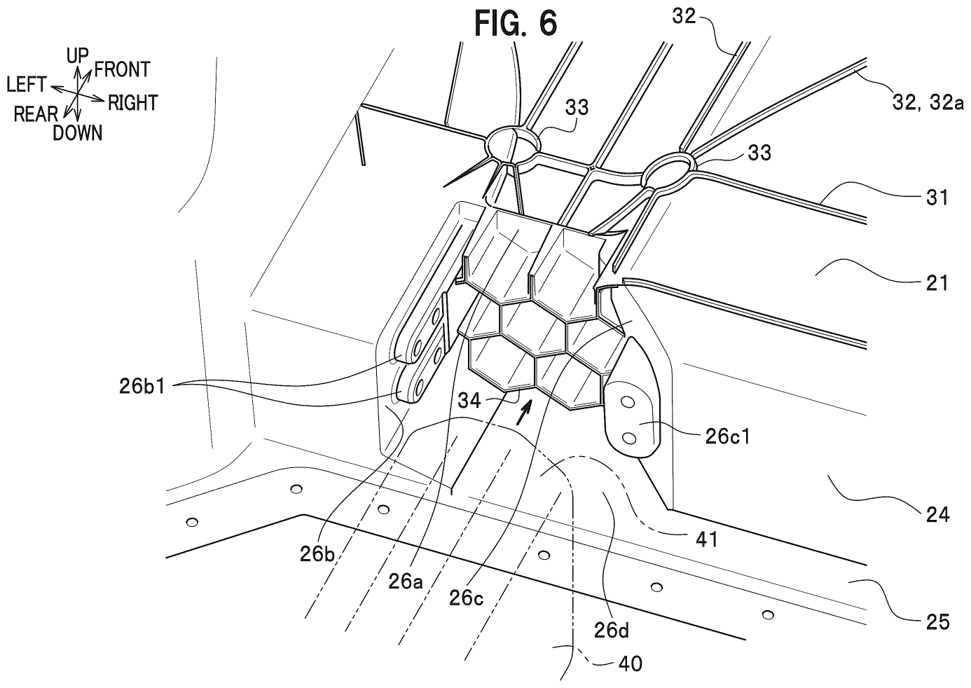

As shown in FIGS. 4 and 6, the rear floor panel part 20 includes a pair of right-left rear frame coupling parts 26 as parts to be coupled with the rear frames 40.

Each rear frame coupling part 26 is formed across the rear wall part 24 and the second lower wall part 25 and is a recessed part which is recessed forward. The rear frame coupling part 26 includes a facing wall 26a, an outer wall 26b, an inner wall 26c, and a lower wall 26d.

The facing wall 26a is a part of the rear wall part 24 of the rear floor panel main body and extends in the width direction and an up-down direction.

The outer wall 26b is a part of the rear wall part 24 of the rear floor panel main body and extends rearward from an outer end in the vehicle width direction of the facing wall 26a. The rear frame 40 is coupled to the outer wall 26b with bolts or the like.

In the present embodiment, the outer wall 26b is formed with protrusions (bases) 26b1 which protrude inward in the vehicle width direction. A tip of the rear frame 40 is fixed to the protrusions 26b1 with bolts inserted into holes formed in inside tip surfaces in the vehicle width direction of the protrusions 26b1. Additionally, heads of the bolts are accommodated in a space of an outer side in the vehicle width direction of the protrusions 26b1.

The inner wall 26c is a part of the rear wall part 24 of the rear floor panel main body and extends rearward from an inner end in the vehicle width direction of the facing wall 26a. The inner wall 26c is inclined inward in the vehicle width direction as extending rearward. The rear frame 40 is coupled to the inner wall 26c with bolts or the like.

In the present embodiment, protrusions (bases) 26cl protruding rearward are formed on the inner walls 26c. The tip of the rear frame 40 (more specifically, the flange (not shown) attached to the tip of the rear frame 40) is fixed to the protrusion 26cl with bolts inserted into holes formed in a rear tip surface of the protrusion 26c1.

The lower wall 26d is a part of the second lower wall part 25 of the rear floor panel main body and extends rearward from a lower end of the facing wall 26a. A lower end of the outer wall 26b is coupled with a lower end of the inner wall 26c by the lower wall 26d.

The rear frame coupling part 26 is positioned in front of the notch 25a as a rear end of the rear floor panel main body, at a rear of the rear floor panel main body. Further, the rear frame coupling part 26 is provided inward in the vehicle width direction relative to an inner end in the vehicle width direction of the bulged part 11, and at least a part of the rear frame coupling part 26 is arranged in front of a rear end of the bulged part 11. Therefore, the vehicle body rear structure 1 has a short rear overhang of the vehicle body, which achieves weight reduction and improved design flexibility of the vehicle body.

The rear frame coupling part 26 and a front end 41 of the rear frame 40 are positioned in front of a rear end of a drive unit 4. A rear part of the drive unit 4 is arranged between the pair of right-left rear frames 40.

### <Rib Structure>

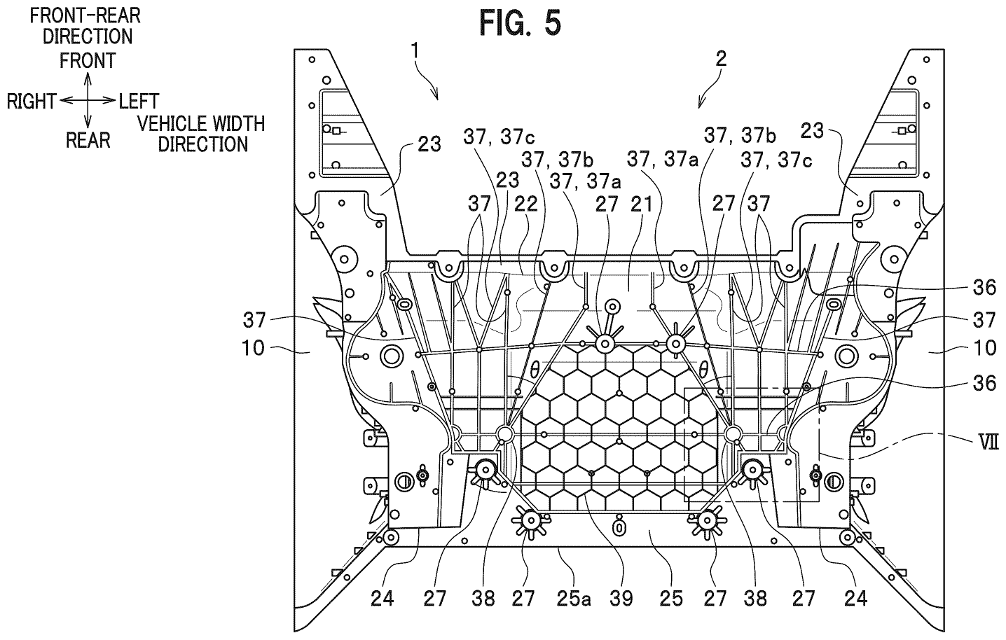

As shown in FIGS. 4 and 5, a plurality of ribs are formed in the rear floor panel main body of the rear floor panel part 20 to improve rigidity, load transmission, and collision energy absorption of the rear floor panel main body.

### <Rib Structure on Upper Surface>

As shown in FIG. 4, the rear floor panel part 20 includes a plurality of right-left ribs 31, a plurality of front-rear ribs 32, a plurality of annular ribs 33, and a pair of right-left facing ribs 34 as ribs erected on an upper side (vehicle inner side). These ribs transmit load in a direction along the ribs to absorb collision energy. In the following description, front-rear ribs 32a, 32c, 37a, 37b, and 37c (see FIG. 5), which are inclined inward in the vehicle width direction as extending forward, are referred to as load transmission ribs.

### <<Right-Left Rib>>

The right-left ribs 31 are erected upward from the upper wall part 21 of the rear floor panel main body and extend in the vehicle width direction. In the present embodiment, ends in the vehicle width direction of the right-left ribs 31 are coupled to the bulged parts 11 of the rear wheel housing parts 10, respectively.

### <<Front-Rear Rib>>

The front-rear ribs 32 are erected upward from the upper wall part 21, the front wall part 22, and the first lower wall part 23 of the rear floor panel main body (erected forward from the front wall part 22) and extend in the front-rear direction. Among the front-rear ribs 32, those located on an outer side in the vehicle width direction are inclined outward in the vehicle width direction as extending forward.

### <<Load Transmission Rib/Upper Rib>>

Among the plurality of front-rear ribs 32, the pair of right-left ribs 32a on the right and left sides at an inner side in the vehicle width direction are load transmission ribs (upper ribs) which are inclined inward in the vehicle width direction as extending forward. Rear ends of the front-rear ribs 32a are located in front of the rear frame coupling parts 26. In the present embodiment, the rear ends of the front-rear ribs 32a are coupled to the facing walls 26a of the rear frame coupling parts 26. Front parts of the front-rear ribs 32a extend in the front-rear direction.

The pair of front-rear ribs 32c on the right and left sides located at the outer side of the vehicle width direction with respect to the pair of front-rear ribs 32a on the right and left sides are load transmission ribs (upper ribs) that are inclined inward in the vehicle width direction as extending forward.

Rear ends of the front-rear ribs 32c are located in front of the rear frame coupling parts 26. In the present embodiment, the rear ends of the front-rear ribs 32c are coupled to the facing walls 26a of the rear frame coupling parts 26. Rear parts of the front-rear ribs 32a extend in the front-rear direction.

Angles θ of inclined parts of the front-rear ribs 32a, 32c with respect to the front-rear direction are 30 degrees or less (30 degrees, for example).

### <<Annular Rib>>

The annular ribs 33 each have a cylindrical shape in planar view and are provided in front of the rear frame coupling parts 26. In the present embodiment, the annular ribs 33 couple the front-rear ribs 32a, which function as load transmission ribs, the front-rear ribs 32 adjacent to the front-rear ribs 32a, and the right-left ribs 31. In other words, the front-rear ribs 32a, the front-rear ribs 32 and the right-left ribs 31 adjacent to the front-rear ribs 32a are formed to extend radially from the annular ribs 33. That is, the front-rear ribs 32a, the front-rear ribs 32 and the right-left ribs 31 adjacent to the front-rear ribs 32a are divided into front parts and rear parts or right parts and left parts at the annular ribs 33.

### <<Facing Rib>>

The facing ribs 34 extend rearward from the facing walls 26a of the rear frame coupling parts 26. In the present embodiment, the facing ribs 34 each have a lattice shape (honeycomb shape, for example) in rear view. Rear ends of the facing ribs 34 face to tips of the rear frames 40, having a space therebetween.

### <Rib Structure on Lower Surface>

As shown in FIG. 5, the rear floor panel part 20 includes, as ribs erected on a lower surface (outer side of the vehicle), a plurality of right-left ribs 36, the plurality of front-rear ribs 37, the plurality of annular ribs 38, and reinforcing ribs 39.

### <<Right-Left Rib>>

The right-left ribs 36 are erected downward from the upper wall part 21 of the rear floor panel main body at positions corresponding to the upper right-left ribs 31 and extend in the vehicle width direction.

### <<Front-Rear Ribs>>

The front-rear ribs 37 are, at positions corresponding to the upper front-rear ribs 32 and at other positions, erected downward from the upper wall part 21, the front wall part 22, and the first lower wall part 23 of the rear floor panel main body (erected rearward from the front wall part 22) and extend in the front-rear direction. Among the plurality of front-rear ribs 37, the front-rear ribs 37 located on outer sides in the vehicle width direction are inclined outward in the vehicle width direction as extending forward.

### <<Load Transmission Rib/Lower Rib>>

Among the plurality of front-rear ribs 37, the pair of front-rear ribs 37a on the right and left sides located at the inner side in the vehicle width direction are, at positions corresponding to the upper front-rear ribs 32a, load transmission ribs (lower ribs) which are inclined inward in the vehicle width direction as extending forward. Rear ends of the front-rear ribs 37a are positioned in front of the rear frame coupling parts 26. In the present embodiment, the rear ends of the front-rear ribs 37a are coupled to the facing walls 26a of the rear frame coupling parts 26. Front ends of the front-rear ribs 32a extend in the front-rear direction.

The front-rear ribs 37b adjacent to the front-rear ribs 37a are load transmission ribs (lower ribs) which are inclined inward in the vehicle width direction as extending forward. Rear ends of the front-rear ribs 37b are positioned in front of the rear frame coupling parts 26. In the present embodiment, the rear ends of the front-rear ribs 37b are coupled to the annular ribs 38.

The pair of front-rear ribs 37b on the right and left sides located at the outer side in the vehicle width direction relative to the pair of front-rear ribs 37b on the right and left sides are load transmission ribs (lower ribs) which are inclined inward in the vehicle width direction as extending forward. Rear ends of the front-rear ribs 37c are positioned in front of the rear frame coupling parts 26. In the present embodiment, the rear ends of the front-rear ribs 37c are coupled to the facing walls 26a of the rear frame coupling parts 26. Rear parts of the front-rear ribs 37b extend in the front-rear direction.

Angles θ of inclined parts of the front-rear ribs 37a, 37b with respect to the front-rear direction are 30 degrees or less (the front-rear ribs 37a, 37c are 30 degrees, and the front-rear ribs 37b are 15 degrees, for example).

### <<Annular Rib>>

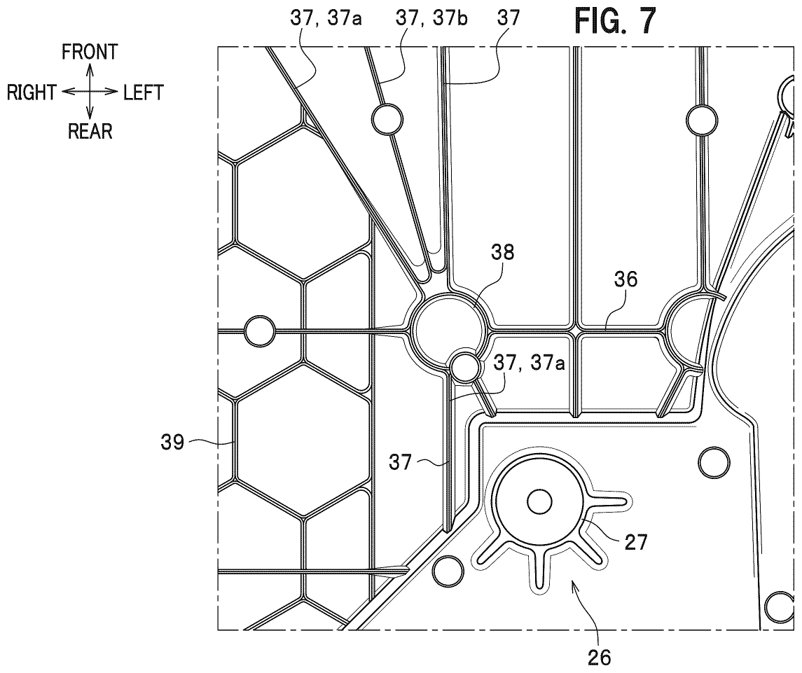

As shown in FIG. 7, the annular rib 38 has a cylindrical shape in planar view and is provided in front of the rear frame coupling part 26. In the present embodiment, the annular rib 38 couples the front-rear ribs 37a, 37b as load transmission ribs to the front-rear rib 37 adjacent to the front-rear rib 37b, and the right-left rib 36. In other words, the front-rear ribs 37a, 37b, the front-rear rib 37 adjacent to the front-rear rib 37b, and the right-left rib 36 are formed to extend radially from the annular rib 38. That is, the front-rear rib 37a, the front-rear rib 37 adjacent to the front-rear rib 37b, and the right-left rib 36 are divided into front parts and rear parts or right parts and left parts by the annular rib 38.

### <<Reinforcing Rib>>

As shown in FIG. 5, the reinforcing ribs 39 serve to enhance rigidity of the rear floor panel part 20 and extends downward from the upper wall part 21 in an area surrounded by the pair of right-left ribs 36 on the front and rear sides and the pair of front-rear ribs 37a on the right and left sides. The reinforcing ribs 39 each have a lattice shape (honeycomb shape, for example) in bottom view. In the present embodiment, the reinforcing ribs 39 are coupled to the pair of right-left ribs 36 on the front and rear sides and the pair of front-rear ribs 37a on the right and left sides. Note that the reinforcing ribs 39 are not limited to have a lattice shape and may include ribs extending only in the front-rear direction, ribs extending only in the right-left direction, or ribs arranged randomly in mixture of these ribs.

### <Upper and Lower Load Transmission Ribs>

As shown in FIGS. 4 and 5, the lower front-rear ribs 37a, 37b, and 37c are provided more than the upper front-rear ribs 32a, 32c as load transmission ribs inclined inward in the vehicle width as extending forward.

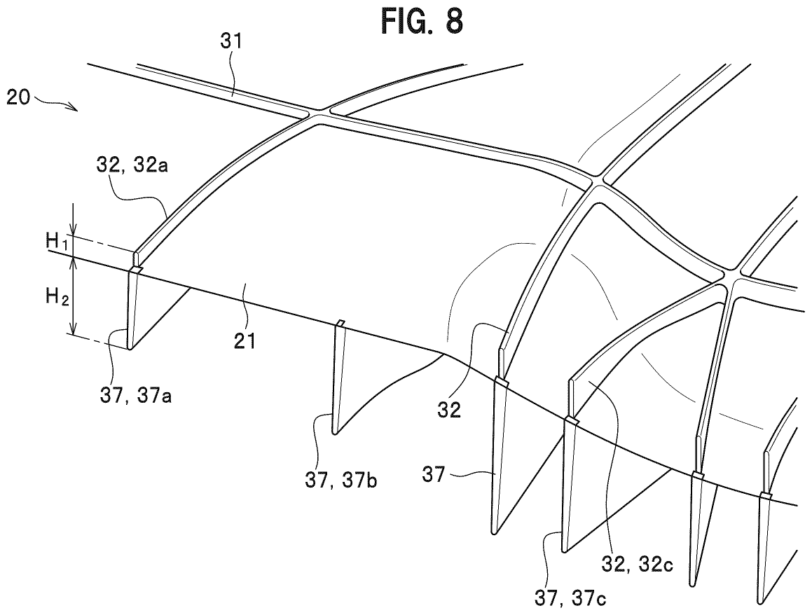

As shown in FIG. 8, in the front-rear load transmission ribs 32a and 37a as load transmission ribs inclined inward in the vehicle width direction as extending forward, a height H₂ of the lower front-rear rib 37a is greater than a height H₁ of the upper front-rear rib 32a. Note that the height relationship is applied to other front-rear ribs 32, 37, right-left ribs 31, 36, and annular ribs 33, 38.

The vehicle body rear structure 1 suppresses accumulation of electrocoat paint to prevent deterioration of paint quality by making the upper front-rear ribs 32a lower than the lower front-rear ribs 37a and by making the number of upper front-rear ribs 32a fewer than the number of lower front-rear ribs 37a and 37b.

Further, as mentioned above, the front-rear ribs 32a, 32c, 37a, 37b, and 37c as load transmission ribs may be able to transmit rear collision load input to the rear frame coupling parts 26 forward. In other words, the rear ends of the front-rear ribs 32a, 32c, 37a, 37b, and 37c may be coupled to the (facing walls 26a of) rear frame coupling parts 26 or may be positioned in front of the (facing walls 26a of) rear frame coupling parts 26 to be separated from the (facing walls 26a of) rear frame coupling parts 26.

### <Rear Frame>

As shown in FIGS. 3 and 4, the rear frames 40 are metal tubular members extending in the front-rear direction. The rear frames 40 each have a closed cross-sectional shape (octagonal shape in the present embodiment) in front view. The rear frame 40 extends rearward from the rear floor panel part 20. A front part of the rear frame 40 is overlapped with the rear floor panel part 20 in planar view. In contrast, a rear part of the rear frame 40 protrudes rearward the rear floor panel part 20 in planar view. The front end 41 of the rear frame 40 is coupled to the rear frame coupling part 26. A bumper beam (not shown) is installed between rear ends of the pair of right-left rear frames 40.

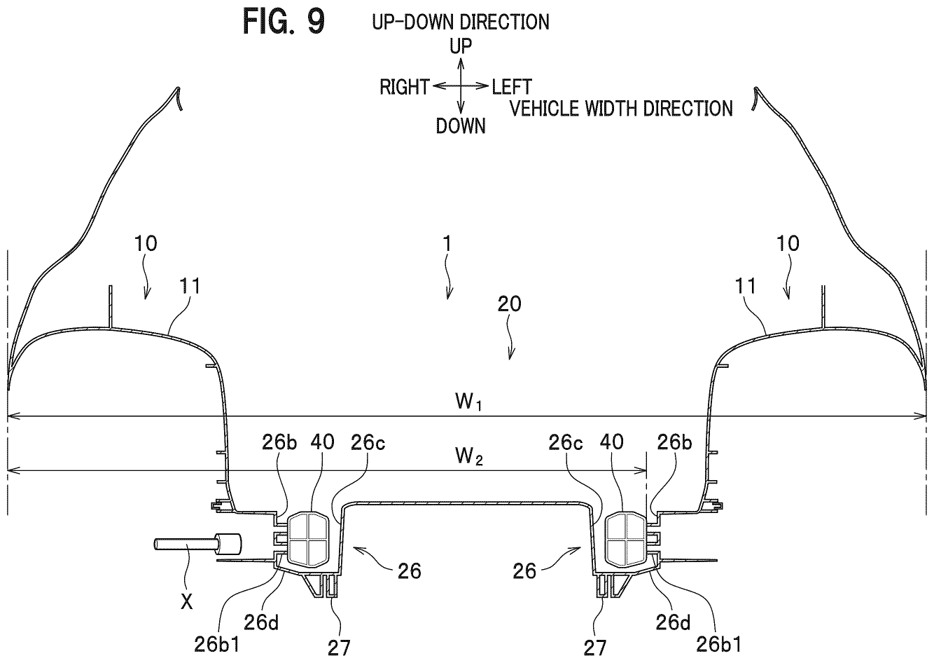

As shown in FIG. 9, a distance W₂ between the rear frame 40 and the rear frame coupling part 26 at one side (left side, for example) in the vehicle width direction and a vehicle body end at the other side in the vehicle width direction (right side, for example) is located within 70% (and greater than 50%) of an entire vehicle body width W₁.

### <Rear Frame Mounting Structure>

As shown in FIGS. 4 and 6, the front end 41 of the rear frame 40 is coupled to the rear frame coupling part 26, with a state that the front end 41 is separated from the facing ribs 34 to face each other. In other words, an outer wall of the front end 41 of the rear frame 40 is attached to an outer wall 26b of the rear frame coupling part 26 with bolts. Here, the protrusions 26b1 of the outer wall 26b is integrated with a lower part of the bulged part 11 and is accessible from an outer side in the vehicle width direction of the bulged part 11. Therefore, bolt fastening can be performed from the outer side in the vehicle width direction of the bulged part 11 of the rear wheel housing part 10 using a jig X (see FIG. 9).

As shown in FIG. 3, the rear frame coupling part 26, that is, the front end 41 of the rear frame 40 coupled to the rear frame coupling part 26 is arranged at a position overlapping with the rear wheel 3 in side view. The front end 41 of the rear frame 40 may be arranged at a position overlapping with a wheel 3a of the rear wheel 3 in side view, or may be arranged at a position overlapping with a tire 3b of the rear wheel 3. In the present embodiment, a part coupled to the rear frame 40 at the outer wall 26b is arranged at a position, in side view, overlapping with the tire 3b of the rear wheel 3, and is accessible from a vehicle outer side (space, in which the rear wheel 3 is accommodated, formed at an outer side in the vehicle width direction of the bulged part 11) of the bulged part 11 of the rear wheel housing part 10).

As shown in FIGS. 4 and 6, the inner wall of the front end 41 of the rear frame 40 is attached with bolt fastening to the inner wall 26c of the rear frame coupling part 26 via a flange member (not shown). The bolt fastening can be performed from a rear side of the inner wall 26c.

### <Drive Unit Mounting Structure>

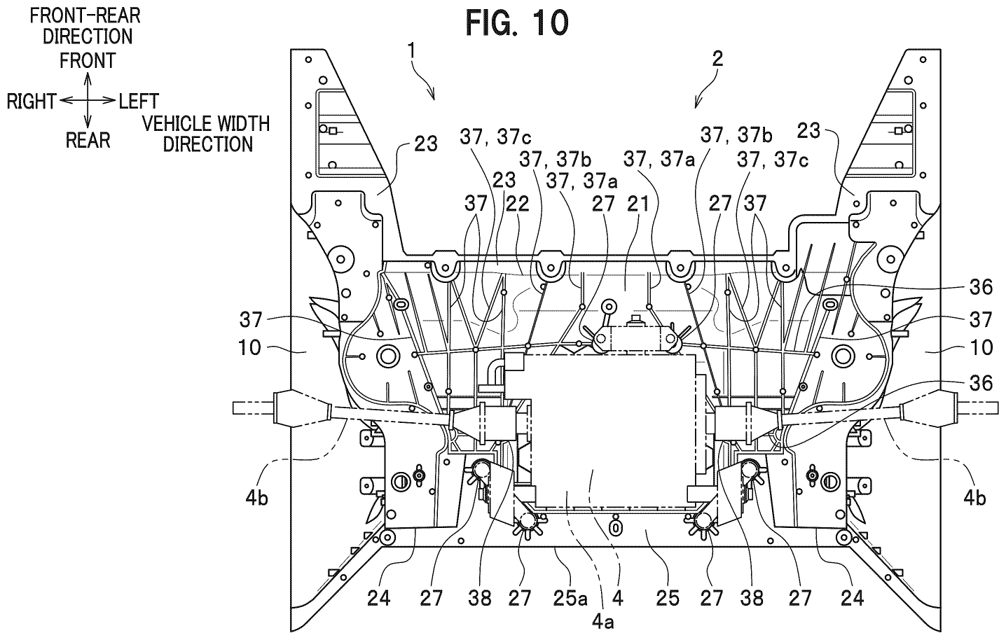

As shown in FIG. 10, the drive unit 4 includes a power source (motor, for example) 4a for rotating a pair of right-left rear wheels 3, and a pair of right-left transmission members (shafts, for example) 4b for transmitting rotational force of the power source 4a to the rear wheels 3. The drive unit 4, more specifically, the power source 4a of the drive unit 4, is arranged in an area surrounded by the upper wall part 21, the front wall part 22, and the rear wall part 24 under the upper wall part 21, and is mounted to a plurality of drive unit mounting parts 27 with bolt fastening or the like. The drive unit mounting parts 27 are arranged to surround the reinforcing ribs 39 described below.

The drive unit mounting parts 27 are provided on each of the lower walls 26d of the pair of right-left rear frame coupling parts 26. The drive unit mounting parts 27 are provided on the rear frame coupling parts 26, which have improved strength due to coupling with the rear frames 40, so that the drive unit 4 can be held in place suitably.

### <Load Transmission During Rear Collision>

During rear collision of a vehicle, rear collision load is transmitted from the pair of right-left rear frames 40 to the rear frame coupling parts 26 of the vehicle body rear structure 1. The rear collision load transmitted to the rear frame coupling parts 26 is dispersed in the vehicle width direction and is transmitted forward through the upper front-rear ribs 32 and the lower front-rear ribs 37. Therefore, the vehicle body rear structure 1 can effectively transmit the rear collision load and can absorb collision energy effectively with the entire structure including a middle part in the vehicle width direction of the rear floor panel part.

Here, during rear collision of a vehicle, the rear frames 40 deform such that rear ends thereof are raised. In short, the upper front-rear ribs 32 deform in a compression direction, while the lower front-rear ribs 37 deform in a tension direction. In the vehicle body rear structure 1, the lower front-rear ribs 37, which deform in the tension direction, are longer in the up-down direction and more than the upper front-rear ribs 32, which deform in the compression direction, so that the rear collision load can be effectively transmitted through the lower front-rear ribs 37 which are hard to deform.

Further, in the vehicle body rear structure 1, the angles θ with respect to the front-rear direction of the front-rear ribs 32a, 32c, 37a, 37b, and 37c, as load transmission ribs, are set to 30 degrees or less, which suppresses deformation of the ribs and the rear collision load is transmitted appropriately.

In addition, in the vehicle body rear structure 1, rigidity at the middle part in the vehicle width direction is improved by the reinforcing ribs 39, thereby suppressing deformation of the rear floor panel main body due to rear collision load and transmitting rear collision load more suitably.

In addition, in the vehicle body rear structure 1, the rear collision load is dispersed to the plurality of front-rear ribs 32 and 37 by the annular ribs 33 and 38, thereby transmitting the rear collision load more suitably.

The vehicle body rear structure 1 according to the embodiment of the present invention is a vehicle body rear structure 1 integrally provided with the rear wheel housing parts 10, and the rear frame coupling parts 26 which are coupled with the rear frames 40, by die-cast molding. Each rear wheel housing part 10 includes the bulged part 11 which is bulged inward in the vehicle width direction to cover the rear wheel 3, and at least a part of each of the rear frame coupling parts 26 is arranged in front of the rear end of the bulged part 11.

Thus, in the vehicle body rear structure 1, the rear frames 40 can be arranged forward so that rear overhang of the vehicle body can be shortened. In other words, the vehicle body rear structure 1 can achieve weight reduction and improve freedom in vehicle body design.

In the vehicle body rear structure 1, the rear frame coupling parts 26 are arranged at positions in the distance in the vehicle width direction from one end of the vehicle body in the vehicle width direction, the distance being within 70% of the entire vehicle body width.

Therefore, the vehicle body rear structure 1 can receive load by both of the pair of right-left rear frames 40 even during offset rear collision. In other words, the vehicle body rear structure 1 can reduce rear collision load input to the right-left rear frames 40 during the offset rear collision and achieve weight reduction including the rear frames 40.

In the vehicle body rear structure 1, the rear floor panel part 20 has the facing ribs 34 extending in the front-rear direction, and the facing ribs 34 are arranged at positions to face the front ends 41 of the rear frames 40.

Therefore, the vehicle body rear structure 1 can appropriately receive and transmit rear collision load from the rear frames 40. Further, in the vehicle body rear structure 1, a length of the facing rib 34 can be adjusted according to a position of the front end 41 of the rear frame 40, which improves installation position freedom of the rear frame 40.

The vehicle body rear structure 1 has the pair of right-left rear wheel housing parts 10 and the rear floor panel part 20 to couple the pair of right-left rear wheel housing parts 10 integrally formed by die-cast molding. The rear frame coupling parts 26 are provided on the rear floor panel part 20.

Therefore, the vehicle body rear structure 1 can improve the degree of installation position freedom of the rear frame coupling parts 26. In addition, the vehicle body rear structure 1 can disperse the rear collision load from the rear frames 40 to the right-left rear wheel housing parts 10, so that the rear frames 40 can be formed smaller to shorten rear overhang.

In the vehicle body rear structure 1, the rear end of the rear floor panel part 20 is positioned in front of the rear end of the bulged parts 11 in the pair of right-left rear wheel housing parts 10 between the pair of right-left rear wheel housing parts 10. Also, the rear frame coupling parts 26 are provided in front of the rear end of the rear floor panel part 20.

Therefore, in the vehicle body rear structure 1, even when the rear overhang is shortened, a space for component layout can ensured and freedom in body design can be ensured. Further, in the vehicle body rear structure 1, the pair of right-left rear wheel housing parts 10 and rear floor panel part 20 are formed as a single die-cast part 2, which can downsize and reduce weight of the rear floor structure.

In the vehicle body rear structure 1, the front ends 41 of the rear frames 40 are positioned in front of the rear end of the drive unit 4 arranged between the pair of right-left rear frames 40.

Therefore, the vehicle body rear structure 1 can shorten rear overhang while ensuring arrangement space for the drive unit 4. Further, the vehicle body rear structure 1 can firmly hold the drive unit 4.

In the rear structure 1, the rear frame coupling parts 26 are provided inward in the vehicle width direction with respect to the inner ends in the vehicle width direction of the bulge parts 11.

Therefore, in the vehicle body rear structure 1, the rear frames 40 can be further arranged forward.

In the vehicle body rear structure 1, the rear frame coupling parts 26 are configured to couple the rear frames 40 from the vehicle outside of the rear wheel housing parts 10.

Therefore, in the vehicle body rear structure 1, the rear frames 40 can be arranged forward and deterioration in mounting workability can be prevented.

In the vehicle body rear structure 1, the rear frame coupling parts 26 are arranged to position so as to overlap the rear wheels 3 in side view.

Therefore, in the vehicle body rear structure 1, the rear frame 40 can be arranged forward so that rear overhang of the vehicle body can be shortened.

The embodiment of the present invention is described above, but is not limited thereto and may be modified as appropriate within the scope of the present invention.

What is claimed is:

1. A vehicle body rear structure comprising: rear wheel housing parts and a rear floor panel part having rear frame coupling parts to be coupled with rear frames, which are integrally provided by die-cast molding, wherein,
the rear wheel housing parts include bulged parts which are bulged inward in a vehicle width direction to cover rear wheels, and
at least a part of the rear frame coupling parts is arranged in front of rear ends of the bulged parts.

2. The vehicle body rear structure according to claim 1 wherein the rear frame coupling parts are arranged at positions in a distance in the vehicle width direction from one end of the vehicle body in the vehicle width direction, the distance being within 70% of the entire vehicle body width.

3. The vehicle body rear structure according to claim 1, wherein
the rear floor panel part has facing ribs extending in a front-rear direction, and
the facing ribs are provided at positions facing front ends of the rear frames.

4. The vehicle body rear structure according to claim 1 comprising:
the pair of right-left rear wheel housing parts; and
the rear floor panel part to couple the pair of right-left rear wheel housing parts integrally formed by die-cast molding, wherein
the rear frame coupling parts are provided on the rear floor panel part.

5. The vehicle body rear structure according to claim 4, wherein a rear end of the rear floor panel part is positioned in front of rear ends of the bulged parts 11 in the pair of right-left rear wheel housing parts between the pair of right-left rear wheel housing parts, and
the rear frame coupling parts are provided in front of the rear end of the rear floor panel part.

6. The vehicle body rear structure according to claim 1, wherein front ends of the rear frames are positioned in front of a rear end of a drive unit arranged between the pair of right-left rear frames.

7. The vehicle body rear structure according to claim 1, wherein the rear frame coupling parts are provided inward in the vehicle width direction with respect to inner ends in the vehicle width direction of the bulge parts.

8. The vehicle body rear structure according to claim 1, wherein the rear frame coupling parts are configured to couple the rear frames from a vehicle outside of the rear wheel housing parts.

9. The vehicle body rear structure according to claim 1, wherein the rear frame coupling parts are arranged to position so as to overlap the rear wheels in side view.
